(19) United States
(12) Patent Application Publication
(10) Pub. No.: US 2020/0082317 A1
(43) Pub. Date: Mar. 12, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Kosuke KOTAKE, Nagoya-shi (JP); Ryosuke TANIMURA, Toyota-shi (JP); Yuki ITO, Iwakura-shi (JP); Akira NISHIDA, Toyota-shi (JP); Zekai QIU, Nisshin-shi (JP); Kenichi HAGIYA, Nagoya-shi (JP); Naoki YAMAMURO, Nagoya-shi (JP)

(73) Assignee: TOYOTA JIDOSHA KABUSHIKI KAISHA, Toyota-shi (JP)

(21) Appl. No.: 16/567,452

(22) Filed: Sep. 11, 2019

(30) Foreign Application Priority Data
Sep. 11, 2018 (JP) 2018-169753

(51) Int. Cl. G06Q 10/06; G06Q 30/02

(52) U.S. Cl. CPC G06Q 10/06314; G06Q 30/0201

(57) ABSTRACT

An information processing apparatus acquires for each of a plurality of users, user information including information relating to user's preferences for a place of departure, date and time of departure from the place of departure, one or more passing spots, staying time at each passing spot, destination and date and time of arrival at destination. Furthermore, the information processing apparatus extracts a plurality of first users who move in a first vehicle from among the plurality of users based on the user information on each of the plurality of users. The information processing apparatus then creates a movement schedule using the first vehicle based the user information on the plurality of first users.

### CROSS REFERENCE TO THE RELATED APPLICATION

This application claims the benefit of Japanese Patent Application No. 2018-169753, filed on Sep. 11, 2018, which is hereby incorporated by reference herein in its entirety.

### BACKGROUND

### Technical Field

The present disclosure relates to an information processing apparatus, an information processing method, and a non-transitory storage medium.

### Description of the Related Art

Use of so-called ride sharing becoming widespread in recent years, the ride sharing being a moving style in which a plurality of users share the same vehicle. Furthermore, techniques for matching a plurality of users for use of such ride sharing are being developed.

Patent document 1 discloses a technique for determining whether or not owners of terminals ride in the same vehicle.

### CITATION LIST

### Patent Document

[Patent document 1] Japanese Patent Laid-Open No. 2011-237842

### SUMMARY

It is an object of the present disclosure to provide a movement schedule better matching users' preferences in traveling or the like in a mode in which a plurality of users move in the same vehicle.

An information processing apparatus according to a first aspect of the present disclosure may be provided with a controller comprising at least one processor configured to execute: acquiring for each of a plurality of users, user information including information relating to user's preferences for a place of departure, date and time of departure from the place of departure, one or more passing spots, staying time at each passing spot, destination and date and time of arrival at destination; extracting a plurality of first users who move in a first vehicle from among the plurality of users based on the user information on each of the plurality of users; and creating a movement schedule using the first vehicle based on the user information on the plurality of first users.

An information processing method according to a second aspect of the present disclosure may cause a computer to execute: a step of acquiring for each of a plurality of users, user information including information relating to user's preferences for a place of departure, date and time of departure from the place of departure, one or more passing spots, staying time at each passing spot, destination and date and time of arrival at destination; a step of extracting a plurality of first users who move in a first vehicle from among the plurality of users based on the user information on each of the plurality of users; and a step of creating a movement schedule using the first vehicle based on the user information on the plurality of first users.

A non-transitory storage medium according to a third aspect of the present disclosure may be a non-transitory storage medium that stores a program for causing a computer to execute: a step of acquiring for each of a plurality of users, user information including information relating to user's preferences for a place of departure, date and time of departure from the place of departure, one or more passing spots, staying time at each passing spot, destination and date and time of arrival at destination; a step of extracting a plurality of first users who move in a first vehicle from among the plurality of users based on the user information on each of the plurality of users; and a step of creating a movement schedule using the first vehicle based on the user information on the plurality of first users.

The present disclosure can provide a technique for providing a movement schedule better matching users' preferences in travel or the like in a mode in which a plurality of users move in the same vehicle.

### BRIEF DESCRIPTION OF THE DRAWINGS

FIG. 1 is a diagram illustrating a schematic configuration of an information processing system according to a first embodiment;

FIG. 2 is a diagram illustrating part of a hardware configuration of a management server;

FIG. 3 is a block diagram schematically illustrating an example of respective configurations of a user terminal and the management server constituting the information processing system according to the first embodiment;

FIGS. 4A to 4C are diagrams illustrating an example of an operation screen when a predetermined application is operated at a user terminal;

FIG. 5 is a flowchart illustrating a scheduling processing flow;

FIG. 6 is a diagram illustrating an example of a table configuration of user information stored in a user information DB; and

FIG. 7 is a diagram illustrating an example of a table configuration of schedule information stored in a schedule information DB.

### DESCRIPTION OF THE EMBODIMENTS

In the information processing apparatus according to the first aspect of the present disclosure, the controller may acquire user information. on each of the plurality of users. The user information may include information relating to preferences for movement of each user. Here, the “movement” is assumed to be such a movement that the user departs from a certain place of departure and arrives at a certain destination after going through one or more passing spots. It is assumed that the user will stay for a certain period at one or more passing spots in the middle of the “movement.” More specifically, the user information may include information relating to the user's preferences for a place of departure, date and time of departure from the place of departure, one or more passing spots, staying time at each passing spot, destination and date and time of arrival at destination.

Furthermore, when preference contents about a movement according to the user information overlap with one another, the users may be able to move according to the respective users' preferences even when the users move in the same vehicle. Thus, the controller may extract a plurality of first users who move in a first vehicle from among the plurality of users based on user information on each of the plurality of users. That is, the plurality of first users may be extracted as users to be matched to the first vehicle.

Furthermore, the controller may create a movement schedule using the first vehicle based on user information on the plurality of first users matched to the first vehicle. This makes it possible to create a movement schedule according to preferences of the plurality of first users whose preference contents for movement overlap with one another. Therefore, it is possible to provide a movement schedule better matching the users' preferences in travel or the like in a mode in which the plurality of users move in the same vehicle.

Hereinafter, more specific embodiments of the present disclosure will be described based on the accompanying drawings. Note that sizes, materials, shapes, relative arrangements and the like of components described in the present embodiment are not intended to exclusively limit the technical scope of the present disclosure to them unless specified otherwise.

### FIRST EMBODIMENT

(System Overview)

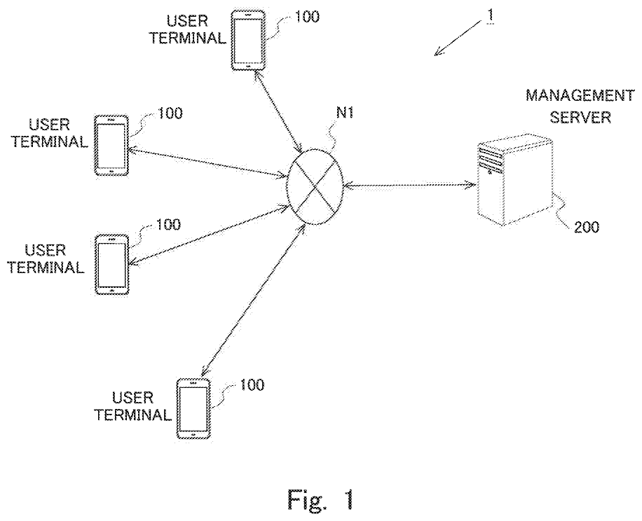

FIG. 1 is a diagram illustrating a schematic configuration of an information processing system according to the present embodiment. The information processing system 1 is constructed to include a user terminal 100 owned by each user and a management server 200. Note that there are as many user terminals 100 as users who use the information processing system 1.

In the information processing system 1, each user terminal 100 and the management server 200 are connected to one another via a network N1. A WAN (Wide Area Network) which is a world-wide public communication network such as the Internet or other communication networks may be adopted as the network N1. The network N1 may also include a telephone communication network of mobile phones or the like or a wireless communication network such as WiFi.

A predetermined application for using a scheduling service in the information processing system 1 is installed in each user terminal 100. Here, the scheduling service refers to a service that creates a schedule about travel in a mode in which a plurality of users travel and move in the same vehicle and provides the schedule to each user according to preferences of each user. Each user operates the predetermined application at the user terminal 100 and can thereby register information of each user (hereinafter referred to as “user information”) needed to use the scheduling service in the management server 200.

The management server 200 is a server that manages the registered user information. The management server 200 executes a scheduling process for providing the scheduling service based on the registered user information. Here, the “scheduling process” refers to a process that extracts a plurality of users who move in the same vehicle according to preference contents relating to movement of each user from among the plurality of users who have registered the user information in the management server 200 and creates a movement schedule of the vehicle in which the extracted plurality of users ride. Note that details of the scheduling process will be described later. The management server 200 transmits the movement schedule created by the scheduling process to each user terminal 100.

(Hardware Configuration of Server)

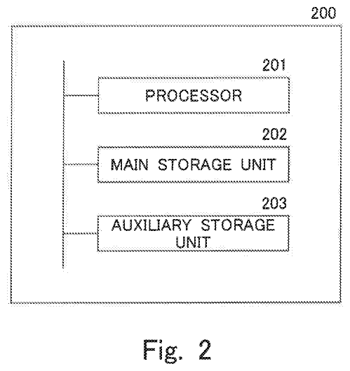

Here, a hardware configuration of the management server 200 will be described based on FIG. 2. FIG. 2 is a diagram illustrating part of a hardware configuration of the management server 200. The management server 200 is constructed of a general computer.

The management server 200 is provided with a processor 201 such as a CPU or DSP, a main storage unit 202 such as a read-only memory (ROM) and a random access memory (RAM), an auxiliary storage unit 203 such as an EPROM, a hard disk drive (HDD) and removable media. Here, the removable media are, for example, a flash memory such as a USE memory or SD card or a disk recording medium such as a CD-ROM, a DVD disk or a blue-ray disk.

In the management server 200, the auxiliary storage unit 203 stores an operating system (OS), various programs, various information tables or the like. Furthermore, in the management server 200, the processor 201 loads a program stored in the auxiliary storage unit 203 into the main storage unit 202 and executes the program, and can thereby implement various functional modules as will be described later. However, some or all functional modules in the management server 200 may also be implemented by a hardware circuit such as ASIC or FPGA. Note that the management server 200 need not always be implemented in a single physical configuration, but may be constructed of a plurality of computers cooperating with one another.

(System Configuration)

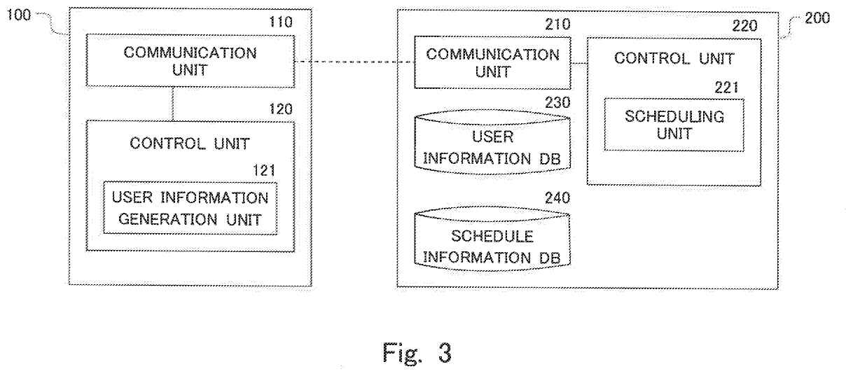

Next, respective functional configurations of the user terminal 100 and the management server 200 constituting the information processing system 1 according to the present embodiment will be described based on FIG. 3. FIG. 3 is a block diagram schematically illustrating an example of the respective configurations of the user terminal 100 and the management server 200 constituting the information processing system 1 according the present embodiment.

(User Terminal)

The user terminal 100 constructed of a computer including a processor, a main storage unit and an auxiliary storage unit. Examples of the user terminal 100 include a smartphone, a tablet computer, a mobile computer, a wearable computer, a wireless storage, a mobile phone and a handy terminal. The user terminal 100 may also be a personal computer connected to the management server 200 via the network N1.

The user terminal 100 includes a communication unit 110 and a control unit 120. The communication unit 110 is communication means for connecting the user terminal 100 to the network Ni. The communication unit 110 can communicate with other apparatuses including the management server 200 using a mobile communication service of 3G (3rd Generation) or LTE (Long Term Evolution) or the like via the network N1.

The control unit 120 has a function of performing calculation processing to control the user terminal 100. A control unit 220 can be implemented by a processor. Furthermore, the processor loads a program stored in the auxiliary storage unit into the main storage unit and executes the program, and can thereby implement various functional modules included in the control unit 120.

Here, the control unit 120 includes a user information generation unit 121 as afunctional module. The information generation unit 121 generates user information based on an input operation performed by the user on an input output unit of the user terminal 100 after operating the above predetermined application.

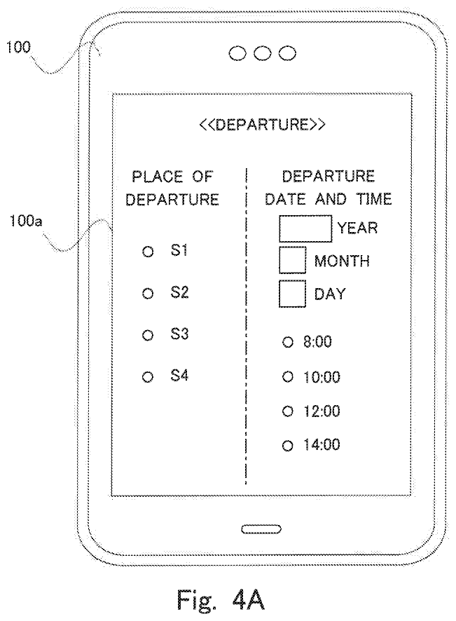

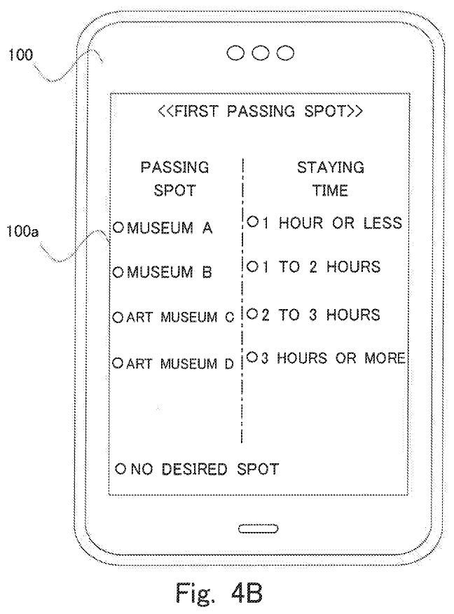

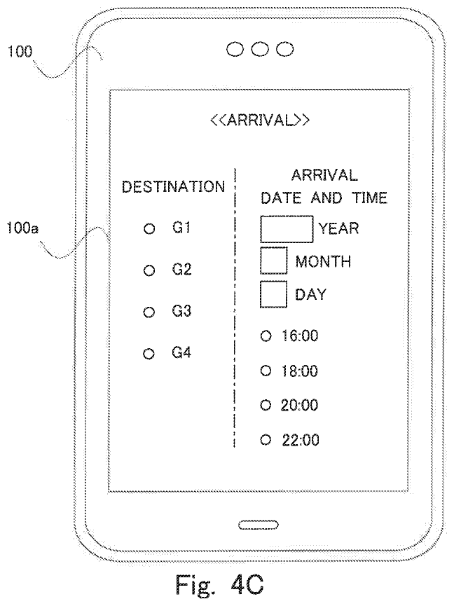

FIG. 4A to 4C are diagrams illustrating an example of an operation screen displayed on a touch panel display 100a included in the input/output unit of the user terminal 100 when a predetermined application is operated at the user terminal 100. FIG. 4A illustrates an example of an operation screen for the user to input preferences for a place of departure and departure date and time in a movement. FIG. 4B illustrates an example of an operation screen for the user to input preferences for a passing spot and a staying time at the passing spot in the movement. FIG. 4C illustrates an example of an operation screen for the user to input preferences for a destination and arrival time in the movement.

On the operation screen illustrated in FIG. 4A, the user can select a desired place of departure from among four candidates for the place of departure (“S1,” “S2,” “S3,” “S4”). Furthermore, on the operation screen illustrated in FIG. 4A, the user can input a desired departure date and can further select a desired departure time from among four departure time candidates (“8:00,” “10:00,” “12:00,” “14:00”).

The operation screen illustrated in FIG. 4B is an operation screen to input preferences for a first passing spot and a staying time at the first passing spot. The operation screen illustrated in FIG. 4B allows the user to select a desired first passing spot from among four first passing spot candidates (“museum A,” “museum B,” “art museum C” and “art museum D”). When no place is included as the desired passing spot in the four first passing spot candidates on the operation screen illustrated in FIG. 4B, the user can select “no desired spot.” The user can further select a staying time at the desired first passing spot from among four staying time candidates (“1 hour or less,” “1 to 2 hours,” “2 to 3 hours” and “3 hours or more)” on the operation screen illustrated in FIG. 4B. Note that in a predetermined application, the user can input preferences for each passing spot other than the first passing spot (e.g., “second passing spot,” “third passing spot”) and the staying time at each passing spot in a movement on an operation screen similar to the operation screen illustrated in FIG. 4B.

On the operation, screen illustrated in FIG. 4C, the user can select a desired destination from among four candidates for the destination (“G1,” “G2,” “G3,” “G4”). The user can further input a desired arrival date on the operation screen illustrated in FIG. 4C and furthermore, the user can select a desired arrival time from among four arrival time candidates (“16:00,” “18:00,” “20:00,” “22:00”). Note that when a departure date and an arrival date in a movement are predetermined to be the same date, the same date as the desired departure date inputted by the user is automatically inputted as the desired arrival date on the operation screen illustrated in FIG. 4A.

The user information generation unit 121 generates user information based on the input operation performed by the user on the above-described operation screen of the user terminal 100. Thus, the user information includes information relating to each user's preferences for a place of departure, date and time of departure from the place of departure, one or more passing spots, staying time at each passing spot, destination and date and time of arrival at destination.

The control unit 120 performs processing of transmitting the user information generated at the user information generation unit 121 to the management server 200 via the communication unit 110. The control unit 120 further performs processing of receiving the schedule information which is information relating to a movement schedule transmitted from the management server 200 via the communication unit 110. The control unit 120 further performs processing of outputting the schedule information received from the management server 200 to the input/output unit of the user terminal 100.

(Management Server)

The management server 200 receives the user information from each user terminal 100 via the network N1. The management server 200 performs a scheduling process based on the received user information on each user. Furthermore, the management server 200 transmits the schedule information which is information relating to the movement schedule created in the scheduling process to each user terminal 100.

The management server 200 includes a communication unit 210, the control unit 220, a user information database (user information DE) 230 and a schedule information database (schedule information DE) 240. The communication unit 210 is communication means for connecting the management server 200 to the network N1. The communication unit 210 includes, for example, a LAN (Local Area Network) interface board and a wireless communication circuit for wireless communication.

The user information DB 230 is a database that stores user information on each user. More specifically, the user information DB 230 stores user information received from each user terminal 100 in association with each user. The schedule information DB 240 is a database that stores schedule information. More specifically, the schedule information DB 240 stores a plurality of users extracted through the scheduling process (hereinafter may also be referred to as a “first user”), a vehicle in which the plurality of first users ride (hereinafter may also be referred to as a “first vehicle”) and the movement schedule by the first vehicle in association with one another.

The user information DB 230 and the schedule information DB 240 are constructed in the auxiliary storage unit 203 by the processor 201 of the management server 200 executing a program of a database management system. The user information DB 230 and schedule information DB 240 are, for example, relational databases.

The control unit 220 includes a function of performing operation processing for controlling the management server 200. The control unit 220 can be implemented by the processor 201. The control unit. 220 executes a process of receiving user information transmitted from each user terminal 100 via the communication unit 110 and a process of transmitting schedule information to each user terminal 100 via the communication unit 210. Furthermore, the control unit 220 executes an information management process such as registration of user information in the user information DB 230 and registration of schedule information in the schedule information DB 240. The control unit 220 includes a scheduling unit 221 which is a functional module that executes a scheduling process.

Note that in the present embodiment, the management server 200 corresponds to the “information processing apparatus” according to the first aspect of the present disclosure.

(Scheduling Process)

Here, details of the scheduling process executed by the scheduling unit 221 will be described. In the scheduling process, a plurality of first users are extracted based on the user information on each user registered in the user information DB 230. At this time, the plurality of first users are extracted as users whose preferences for the movement overlap with one another. Furthermore, a movement schedule of the first vehicle shared by the plurality of first users is created in the scheduling process.

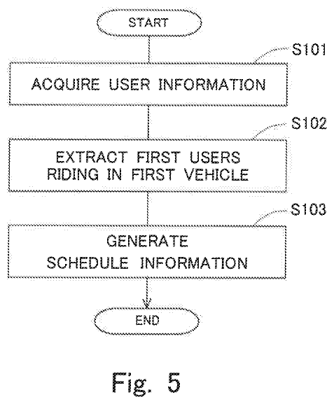

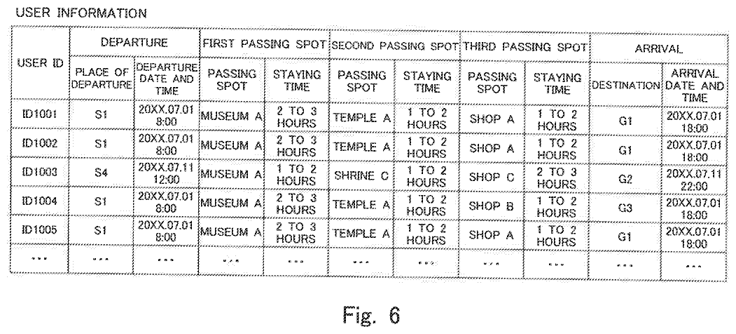

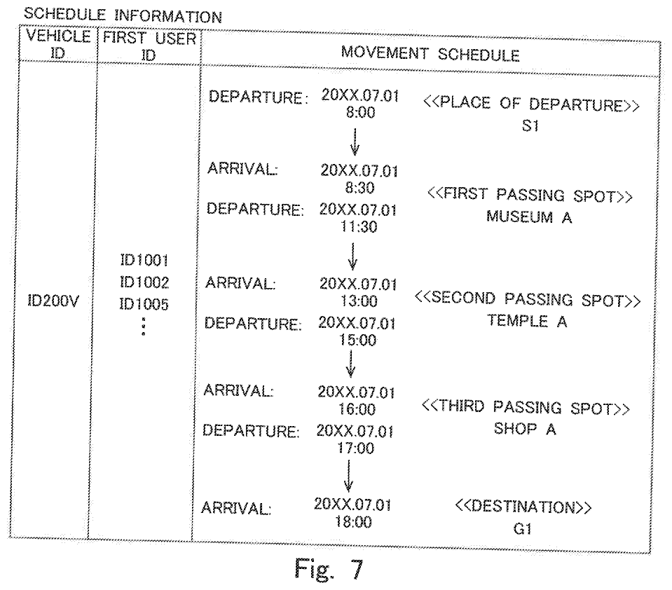

FIG. 5 is a flowchart illustrating a scheduling processing flow executed by the scheduling unit 221. FIG. 6 is a diagram illustrating an example of a table configuration of the user information stored in the user information DB 230. FIG. 7 is a diagram illustrating an example of a table configuration of the schedule information stored in the schedule information DB 240. Note that it is assumed that the scheduling process is executed on the premise that reception of user information from each user terminal 100 has been completed and a sufficient amount of user information is stored in the user information DB 230.

In the flow illustrated in FIG. 5, the user information on each user stored in the user information DB 230 is acquired in S101 first. Here, as illustrated in FIG. 6, the user information table stored in the user information DB 230 is filled in with information relating to each user's preferences included in the user information generated based on the user operation on the operation screens illustrated in FIGS. 4A to 4C in the user terminal 100 of each user.

To be more specific, the user information table includes a user ID field, a departure field, respective passing spot fields (first to third passing spot fields in the case of the user information table illustrated in FIG. 6) and an arrival field. The user ID field is filled in with a user ID which is identification information to identify each user. The departure field is filled in with information relating to a user desired place of departure (place of departure selected by the user in FIG. 4A) and a departure date and time (desired departure date and time inputted by the user in FIG. 4A).

Furthermore, the first passing spot field is filled in with information relating to a user desired first passing spot (first passing spot selected by the user in FIG. 4B) and a staying time (staying time at the first passing spot selected by the user in FIG. 4B). Note that when the user selects “no desired spot” in FIG. 4B, the first passing spot field is filled in with information “no desired spot.” Similarly, the second passing spot field is filled in with information relating to the user desired second passing spot and a staying time at the second passing spot, and the third passing spot field is filled in with information relating to a user desired third passing spot and a staying time at the third passing spot.

Furthermore, the arrival field is filled in with information relating to a user desired destination (destination selected by the user in FIG. 4C) and an arrival date and time (desired arrival date and time inputted by the user in FIG. 4C). Thus, the user information table illustrated in FIG. 6 is filled in with information relating to each user's preferences for a place of departure, departure date and time, first to third passing spots, staying time at each passing spot, destination and arrival date and time in association with each user's user ID.

Next, in S102, a plurality of first. users who move in the first vehicle are extracted based on the user information on each user acquired in S101. More specifically, a plurality of users having the same preferences for a place of departure, departure date and time, first to third passing spots, staying time at each passing spot, destination and arrival date and time in the user information are extracted as the first users. For example, in the user information table illustrated in FIG. 6, the place of departure, departure date and time, first to third passing spots, staying time at each passing spot, destination and arrival date and time corresponding to the user IDs “ID1001,” “ID1002” and “ID1005” are identical. Therefore, at least the users corresponding to the user IDs “ID1001,” “ID1002” and “ID1005” are extracted as the first users in S102.

Next, in S103, schedule information relating to the movement schedule of the first vehicle shared by the plurality of first users extracted in S102 is generated. The schedule information generated here is transmitted to the user terminal 100 of each first user and registered in the schedule information DB 240.

As illustrated in FIG. 7, the schedule information table stored in the schedule information DB 240 includes a vehicle ID field, a first user ID field and a schedule field. The vehicle ID field is filled in with a vehicle ID which is identification information for identifying the first vehicle in which the plurality of first users ride. The first user ID field is filled in with user IDs of the plurality of first users extracted in S102, The schedule field is filled in with the movement schedule of the first vehicle. Here, the movement schedule of the first vehicle inputted to the schedule field is the movement schedule created as the schedule corresponding to preferences for the place of departure, departure date and time, first to third passing spots, staying time at each passing spot, destination and arrival date and time in the user information on the plurality of first users.

For example, in the schedule information table illustrated in FIG. 7, at least the first users corresponding to the user IDs “ID1001,” “ID1002” and “ID1005” are supposed to ride in the same first vehicle (vehicle ID “ID200V”). Therefore, the movement schedule corresponding to the vehicle ID “ID200V” is created as a schedule corresponding to the place of departure, departure date and time, first to third passing spots, staying time at each passing spot, destination and arrival date and time corresponding to the user IDs “ID1001,” “ID1002” and “ID1005” in the user information table illustrated in FIG. 6. Note that the arrival time at each passing spot and departure time from each passing spot in the movement schedule inputted to the schedule field are set by taking into account a distance from the place of departure to the first passing spot, distances between the respective passing spots, a distance from the third passing spot to the destination and predicted road situation, in addition to the staying time at each passing spot.

As described above, according to the present embodiment, a plurality of first users whose preference contents about movement overlap one another are extracted as users who move in the first vehicle. A movement schedule using the first vehicle is generated based on user information on the plurality of first users. It is thereby possible to create the movement schedule in accordance with preferences of the plurality of first users whose preference contents about movement overlap with one another. Therefore, it is possible to allow a plurality of first users to ride in the first vehicle and provide the movement schedule in accordance with preferences of the plurality of first users as the movement schedule using the first vehicle.

Note that a scheduling process has been described by taking a case as an example where the movement schedule using the first vehicle includes three passing spots (first to third passing spots), but the passing spots in the movement need not always be plural. For example, in the above embodiment, there can be a case where “no desired spot” is selected by the user on the operation screen in a predetermined application about two of the first to third passing spots. In this case, the user information includes just one passing spot through which the user wants to pass When such a user is extracted as the first user, the movement schedule includes just one passing spot.

(Modifications)

In the scheduling process according to the above embodiment, a plurality of users having the same preferences for a place of departure, departure date and time, first to third passing spots, staying time at each passing spot, destination and arrival date and time in the user information are extracted as the first users. That is, a plurality of first users are extracted from among a plurality of users on condition that preferences about movement overlap with one another. However, the conditions for extracting the first users in the scheduling process are not limited to such conditions. That is, in the scheduling process, it is also possible to extract users having partially different references about the movement as the first users.

More specifically, there can be a case where there are two (or two sets of) users having the same preferences for the place of departure, departure time, each passing spot and staying time at each passing spot but having different preferences for the destination and arrival time. At this time, a destination and an arrival time desired by one user are assumed to be a first destination and a first arrival time, and a destination and an arrival time desired by the other user are assumed to be a second destination and a second arrival time. In such a case, after the first vehicle arrives at the first destination at the first arrival time, if the first vehicle can move to the second destination by the second arrival time, both the one user and the other user can move in the first vehicle.

Furthermore, there can be a case where two (or two sets of) users have different desired passing spots but those desired passing spots are relatively close to each other and the users can move that distance on foot. That is, a passing spot desired by one user and a passing spot desired by the other user may be located within a range in which both users can move on foot. In such a case, if a passing spot desired by one user and a passing spot desired by the other user are considered to be identical, both the one user and the other user can ride and move in the first vehicle.

As described above, even for users having partially different preferences about the movement, it may be possible to perform the movement that matches their respective preferences using the same vehicle (first vehicle). Thus, in the scheduling process, if it is possible to determine, based on user information on the respective users, that even when the respective users have partially different preferences about the movement, it is possible to form the movement that matches the respective users' preferences using the same vehicle (first vehicle), these users may be extracted as the first users.

### OTHER EMBODIMENTS

The above embodiment is merely an example, and the present disclosure can be changed and implemented as appropriate without departing from the spirit and scope thereof range. Furthermore, the processes and means described in the present disclosure can be implemented in free combination unless there is any technical discrepancy.

Furthermore, a process described as to be executed by one apparatus may be shared and performed by a plurality of apparatuses. Alternatively, a process described as to be executed by different apparatuses may be executed by one apparatus. In a computer system, it is possible to flexibly change in what hardware configuration (server configuration) each function is to be implemented.

The present disclosure can also be implemented by supplying a computer program including the functions described in the above embodiment to a computer and by one or more processors included in the computer reading and executing the program. Such a computer program may be supplied to the computer through a non-transitory computer readable storage medium which is connectable to a system bus of the computer or may be supplied to the computer via a network. The non-transitory computer readable storage medium includes any type of disk such as a magnetic disk (floppy (registered trademark) disk, hard disk drive (HDD) or the like), optical disk (CD-ROM, DVD disk, blue-ray disk or the like), read-only memory (ROM), random access memory (RAM), EPROM, EEPROM, magnetic card, flash memory, optical card or any type of medium suitable for storing electronic instructions.

What is claimed is:

1. An information processing apparatus comprising a controller comprising at least one processor configured to execute:
acquiring for each of a plurality of users, user information including information relating to user's preferences for a place of departure, date and time of departure from the place of departure, one or more passing spots, staying time at each passing spot, destination and date and time of arrival at destination;
extracting a plurality of first users who move in a first vehicle from among the plurality of users based on the user information on each of the plurality of users; and
creating a movement schedule using the first vehicle based on the user information on the plurality of first users.

2. The information processing apparatus according to claim 1, wherein the controller executes:
extracting a plurality of users having same preferences for a place of departure, date and time of departure from the place of departure, one or more passing spots, staying time at each passing spot, destination and date and time of arrival at destination from among the plurality of users as the plurality of first users; and
creating a movement schedule using the first vehicle as a schedule in accordance with a place of departure, date and time of departure from the place of departure, one or more passing spots, staying time at each passing spot, destination and date and time of arrival at destination desired by the plurality of first users.

3. An information processing method causing a computer to execute:
a step of acquiring for each of a plurality of users, user information including information relating to user's preferences for a place of departure, date and time of departure from the place of departure, one or more passing spots, staying time at each passing spot, destination and date and time of arrival at destination;
a step of extracting a plurality of first users who move in a first vehicle from among the plurality of users based on the user information on each of the plurality of users; and
a step of creating a movement schedule using the first vehicle based on the user information on the plurality of first users.

4. A non-transitory storage medium that stores a program for causing a computer to execute:
a step of acquiring for each of a plurality of users, user information including information relating to user's preferences for a place of departure, date and time of departure from the place of departure, one or e passing spots, staying time at each passing spot, destination and date and time of arrival at destination;
a step of extracting a plurality of first users who move in a first vehicle from among the plurality of users based on the user information on each of the plurality of users; and
a step of creating a movement schedule using the first vehicle based on the user information on the plurality of first users.
